(19) United States
(12) Patent Application Publication
(10) Pub. No.: US 2008/0008403 A1
(43) Pub. Date: Jan. 10, 2008

(54) Aseptic package

(76) Inventors: Stuart Fergusson, Kingston (CA); Jeffrey A. Montgomery, Gananoque (CA); Stewart M. Graves, Meifod (GB); Qin Lin, Kingston (CA)

Correspondence Address: POTTER ANDERSON & CORROON LLP;ATTN: KATHLEEN W. GEIGER, ESQ., P.O. BOX 951, WILMINGTON, DE, 19899-0951, US

(21) Appl. No.: 11/803,868

(22) Filed: May 16, 2007

Related U.S. Application Data
(60) Provisional application No. 60/800,911, filed on May 16, 2006.

(51) Int. Cl. B67D 5/00; B65D 30/22; B65D 33/16; B65B 55/02; B65B 43/26

(52) U.S. Cl. 383/40; 53/425; 53/468; 383/66; 383/38

(57) ABSTRACT

A process for making an aseptic sealed product-filled package in disclosed. The process includes the steps of: providing a bag having a preformed filling fitment; filling the bag with product through the filling fitment; and sealing the bag below the filling fitment. The process can further include the step of cutting off at least a portion of the bag above the seal to remove the filling fitment. Also provided is a bag for forming an aseptic product-filled package. The bag includes a pair of corresponding walls of flexible, sealable material, which are sealed about a common periphery to form an internal volume having a product portion and a fitment portion. The product portion and the fitment portion are fluidly connected. The bag further includes a filling fitment attached to at least one of the walls near the common periphery. The package is formable by aseptically sealing at least a part of the fitment portion with the fitment so as to isolate the fitment from the remainder of the bag. Optionally, the package may be formed by the additional step of cutting off at least a part of the bag above the seal including the fitment.

This application claims priority to provisional patent application 60/800,911 filed May 16, 2006.

### FIELD OF THE INVENTION

In one of its aspects, the present invention provides a bag for forming an aseptic package. In another one of its aspects, the present invention provides a process for forming an aseptic package.

### DESCRIPTION OF THE PRIOR ART

Closable bags of flexible material provided with a fitment for filling the bag with product are well-known in the art. This form of packaging is particularly useful for bulk-packaging of certain flowable food products under aseptic conditions. Existing aseptic bulk-bag packaging systems can be classified into various groups based on the sealing technology. Aseptic bulk bags employ fitments that allow the bag to be filled and sealed under aseptic conditions. A major challenge associated with aseptic bulk-bag packaging is sealing the bag after filling.

One known type of packaging seals the fitment with a cap from the top. These type of packages are characterized by a fitment with rigid neck, sealed by a cap on top before and after filing. Filling is performed in an aseptic chamber employing steam and/or a sterilant solution. The cap is removed and reapplied in the aseptic chamber. Patents and applications illustrative of this type of packaging are: International patent application publication number WO03/022314; U.S. Pat. Nos. 5,379,013; 5,678,719; and 5,348,184; and European patents 1 247 749; 0 741 087; and 0 731 037.

Another type of packaging involves heat sealing the fitment with a membrane/foil lid from the top. This type of packaging is characterized by a fitment having a rigid neck sealed on top with a frangible membrane before filling. A foil lid is heat sealed on the fitment rim after filling. Filling is performed in an aseptic chamber, employing a steam sterilization, vacuum lid transfer and heat sealing of the device within the aseptic chamber. Patents illustrative of this type of packaging are: U.S. Pat. No. 4,445,550 and European patent 101 613.

Yet another type of packaging involves heat sealing the fitment with an opposite-wall film or a flap film from the bottom. This type of packaging is characterized by a fitment with a rigid neck sealed on top with a frangible membrane before filling. The fitment is heat sealed from the bottom by a flap or opposite wall of the bag after filling. Filling is performed using sterilizing fluid or steam. The fitment is heat sealed from behind with a flap. Patents and applications illustrative of this type of packaging are: International patent application publication number WO04/031041 and U.S. Pat. Nos. 4,542,530; 4,257,535; and 6,595,391.

These types of aseptic bulk packaging all suffer from some common drawbacks. One is that the fitment remains part of the package after filling. In many applications, this filling fitment serves no purpose other than permitting aseptic filling of the package. This is particularly disadvantageous in that fitments can be the source of leaking and loss of sterility. The fitment is also a weak point with respect to the oxygen barrier.

Further, there is a need to improve this type of packaging by simplifying the fitment, which reduces the cost of producing the package. A fitment that is to be used for both filling and dispensing will be more complex than a fitment that is only used for one operation and therefore more costly. Generally, two simple single-operation fitments will cost less than one complex fitment. Similarly, methods that require multiple sealings contribute to the complexity and consequently the cost of filling.

In the manufacture of smaller packages for use by consumers, such complex fitments, used for both filling and dispensing are common. In such applications, it is common to attach this single dual-purpose fitment near one end or the other of the package. This placement is in order to facilitate the arrangement for dispensing by the consumer.

In the case of bulk packaging (i.e. 55 gallons to 300 gallons) the fitment is commonly designed for filling only and the package is simply cut open for the purposes of dispensing. In this case, fitment positioning is dictated by filling considerations. As a result, the fitment is commonly positioned toward the center of a wall of the container i.e. away from an edge thereof. This improves balancing for filling of such bulk packages. Such bulk packages also tend to be symmetrical to facilitate production.

Package fitments can lead to unused material, particularly around the fitment. Unused material is disadvantageous in that this material tends to suffer from cracking, in addition to increasing the cost of the package. The fitment on the package can cause flex cracking of the film in contact and adjacent to the fitment, once the package is filled, transported and stored.

A particularly preferred type of packaging involves sealing the fitment with a member from the opposite wall. This type of packaging is characterized by a fitment with a rigid neck that is sealed by a member from the opposite wall before and after filling. Filling employs steam sterilization. The sealing member is pulled inside the bag during filling and closes the fitment from the inside. Patents and applications illustrative of this type of packaging are: U.S. Pat. No. 4,731,978 and International patent applications publication numbers WO96/03319 and WO02/085728.

While this design represents an improvement in the art of bulk aseptic packaging, there remains a need for an improved package that addresses the disadvantages associated with the presence of the filling fitment on the package after filling, and the contribution of the fitment to flex cracking of the film in contact and adjacent thereto.

U.S. Pat. No. 4,581,874 describes an apparatus and methods for filling and sealing an aseptic fitmentless pouch. The method described in this patent is very complicated and to the inventors' knowledge, the product therein was never commercialized. The package comprises a pouch formed from two multiple-ply side walls sealed together at marginal edges. Half seals seal together the multiple plies in the side walls adjacent one of the edge seals. A portion of the seal is removable. The removable seal is removed in the aseptic environment, the pouch is filled and resealed within the aseptic environment.

U.S. Pat. No. 6,120,181 teaches a “pillow bag” with an integral filling conduit. The package taught in this patent is a large bag that has no filling fitment and can be sealed after filling, but cannot be filled aseptically.

Thus there remains a need for a bulk aseptic package and a package production process that mitigate the problems associated with the filling fitment during the production, storage and transport of the package.

### SUMMARY OF THE INVENTION

Accordingly, in one aspect, the present invention provides a process for making an aseptic sealed product-filled package. The process includes the steps of: providing a bag having a preformed filling fitment; filling the bag with product through the filling fitment; and sealing the bag below the filling fitment. The process can further include the step of cutting off at least a portion of the bag above the seal to remove the filling fitment.

In another aspect, the present invention provides a bag for forming an aseptic product-filled package. The bag comprises a pair of corresponding walls of flexible, sealable material, which are sealed about a common periphery to form an internal volume having a product portion and a fitment portion. The product portion and the fitment portion are fluidly connected. The bag further includes a filling fitment attached to at least one of the walls near the common periphery. The package is formable by aseptically sealing at least a part of the fitment portion with the fitment so as to isolate the fitment from the remainder of the bag. Optionally, the package may be formed by the additional step of cutting off at least a part of the bag above the seal including the fitment.

### BRIEF DESCRIPTION OF THE DRAWINGS

Embodiments of the present invention will be described with reference to the accompanying drawings, wherein like reference numerals denote like parts, and in which:

FIG. 1 illustrates a schematic depiction of one embodiment of the process of the present invention.

FIG. 2 illustrates a schematic depiction of a second embodiment of the process of the present invention.

FIG. 3 illustrates an embodiment of the bag of the present invention on a filling machine during the step of sterilizing the fitment.

FIG. 4 illustrates an embodiment of the bag of the present invention on a filling machine during the step of filling the bag.

FIG. 5 illustrates an embodiment of the bag of the present invention on a filling machine during the step of cleaning the fitment and filling opening after product filling.

FIG. 6 illustrates an embodiment of the bag of the present invention on a filling machine, during the step of forming a package of the present invention by sealing.

FIG. 7 illustrates an embodiment of the package of the present invention formed by the step of sealing and cutting on a filling machine.

FIG. 8 illustrates an embodiment of the bag of the present invention showing a proposed seal line.

FIG. 9 illustrates an embodiment of the bag of the present invention showing a proposed seal line.

FIG. 10 illustrates an embodiment of the bag of the present invention showing a proposed seal line.

FIG. 11 illustrates an embodiment of the bag of the present invention showing a proposed seal line.

FIG. 12 illustrates an embodiment of the bag of the present invention showing a proposed seal line.

FIG. 13 illustrates an embodiment of the bag of the present invention showing a proposed seal line.

FIG. 14 illustrates an embodiment of the bag of the present invention showing a proposed seal line.

FIG. 15 illustrates an embodiment of the bag of the present invention showing a proposed seal line.

FIG. 16 illustrates an embodiment of the bag of the present invention showing a proposed seal line.

FIG. 17 illustrates an embodiment of the bag of the present invention showing a proposed seal line.

FIG. 18 illustrates an embodiment of the bag of the present invention showing a pre-seal line.

FIG. 19 illustrates a strip of bags of FIG. 9 connected by perforation.

### DETAILED DESCRIPTION OF THE PREFERRED EMBODIMENTS

The size or use of the bag of the present invention is not particularly restricted, although the bag of the present invention is particularly suitable for bulk bag aseptic applications. This type of application requires a filling fitment to permit filling of the bag under aseptic conditions. In the bulk bag aseptic business (i.e. typical volumes of 55 to 300 gallons) most end-users cut the bag open when using the package, and the fitment is used solely for initially filling the package with product.

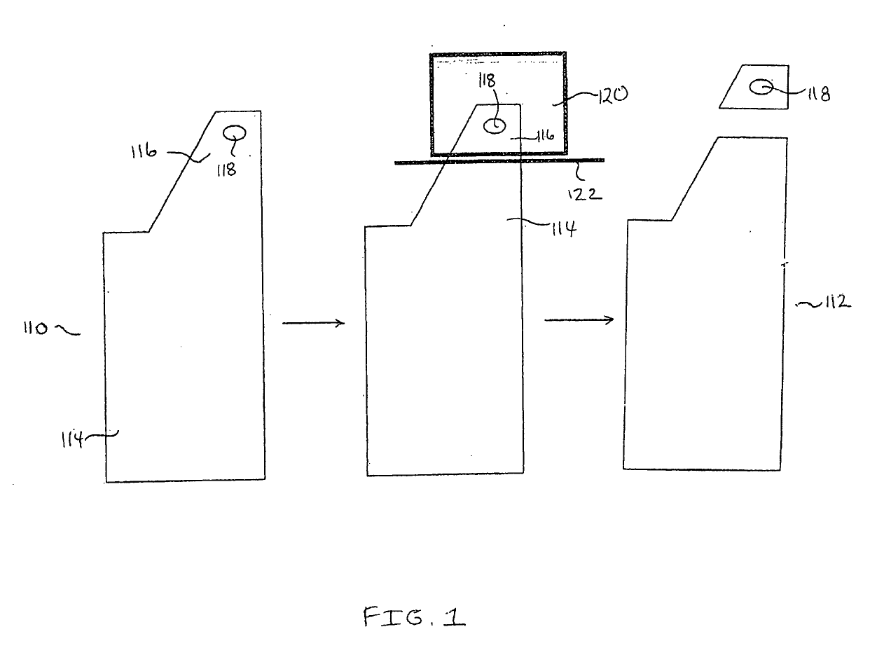

Turning to FIG. 1, the present invention provides a bag 110 for forming an aseptic package 112. The bag 110 includes a product portion 114 and a fitment portion 116, which are fluidly connected to each other. A filling fitment 118 is connected to the fitment portion 116 near a peripheral edge of bag 110. Filling fitment 118 enables aseptic filling of bag 112 with product, e.g. such as through filling head 120. The aseptic package 112 is formed by aseptically sealing and cutting off at least a portion of fitment portion 116 with the fitment 118, e.g. such as through use of a seal and cut bar 122. The bag 110 (and the aseptic package 112 formed therefrom) may further include a dispensing fitment (not shown).

In an embodiment of the invention, the bag is asymmetric in that the fitment portion 116 has a reduced volume relative to the product portion 114 when the bag 110 is expanded through filling. The reduced volume of the fitment portion 116 may be formed from external shaping of the bag, (a “shaped bag”) or may be formed via internal barriers in an otherwise generic i.e. rectangular bag. Such internal barriers are suitably formed by heat sealing. The asymmetric properties of the bag mean that the step of forming the aseptic package 112 by aseptically sealing and, optionally, cutting off, at least a portion of the fitment portion 116 involves forming a shorter seal relative to the entire width of the bag. Further, with a shaped bag, when at least a part of the fitment portion 116 is cut off, less discard material is generated than would otherwise be the case.

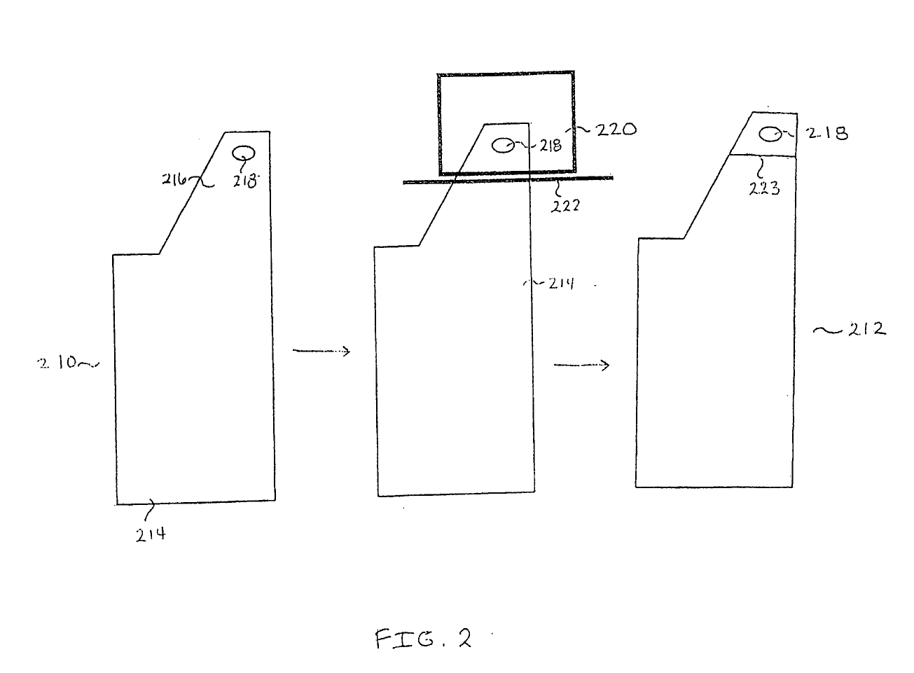

An alternate embodiment of the package of the present invention is shown in FIG. 2. In FIG. 2, the parts are numbered in the two-hundreds, and like parts are shown using the same numbers in the second and third positions.

In the embodiment of the present invention shown in FIG. 2, the aseptic package 212 is formed by sealing, but not cutting off at least a portion of fitment portion 216, so as to form an internal seal 223. This embodiment provides a double barrier of protection i.e. the filling fitment 218 (which as discussed above may be a source of contamination) and internal seal 223 beneath the filling fitment 218, both act as barriers. Further, in the embodiment shown in FIG. 2, there is no need to dispose of the portion of the fitment portion 216 cut off through the sealing and cutting step in the first embodiment.

In both the embodiments shown in FIGS. 1 and 2, the process of forming the aseptic package (112, 212) can further include the step of cleaning the filling fitment (118, 218). Techniques for cleaning a fitment are well known to those of skill in the art. A suitable cleaning step involves injecting a sterilizing fluid into the filling fitment (118, 218). Suitably, this is done after filling with product, but before sealing and cutting off at least a portion of fitment portion (116 in FIG. 1) or before forming the internal seal (223 in FIG. 2). Although in the case of the embodiment in FIG. 1, it may be done between sealing and cutting, and in the case of the embodiment shown in FIG. 2, it may be done after formation of internal seal 223. A suitable sterilizing fluid is steam.

As will be apparent to a person skilled in the art, while there are a number of advantages to the bag 110, 210 of the present invention, more generally the invention provides a process for forming an aseptic sealed product-filled package that has the steps of: providing a bag having a preformed filling fitment; filling the bag through the filling fitment; and sealing the bag below the filling fitment. The process further may include the step of cutting off a portion of the bag above the seal to remove the filling fitment.

While the present invention is suitable for aseptically packaging any flowable material. Preferred flowable food products suitable for use with the present invention include, for example, citrus juices and concentrates (and in particular, orange and grapefruit), apple juice, mango, banana and pineapple pulp and juice, fruit purees, tomato paste and diced tomatoes, and cream and other dairy products.

Materials suitable for forming the bag of the present invention are well known to those of skill in the art. Generally the bag should be sealable and have suitable properties (i.e. barrier, strength, flexibility) for carrying the desired product therein. The number of plies or whether to use a laminate film are decisions within the purview of a person skilled in the art.

In one embodiment, each sidewall of the bag of the present invention is comprised of three plies. The two innermost plies of each side wall are preferably made of any suitable plastic film material, such as linear low-density polyethylene, for example, while the outer ply of each side wall is preferably a barrier lamination including a layer made from a foil material or a suitable metallized substrate, or any other recognized flexible barrier or substrate materials including non-metallized materials. The outer barrier lamination may comprise an outer layer of Nylon, an intermediate layer or foil, and an inner layer of polyethylene. Alternatively, the barrier lamination could comprise an outer layer of polyethylene, an intermediate layer of metallized Nylon, or metallized polyester, or metallized polyvinyl alcohol, and an inner layer of polyethylene.

Other alternate intermediate layers having suitable barrier characteristics include unmetalized polyvinyl alcohol, unmetalized ethyl vinyl alcohol, and metalized ethyl vinyl alcohol.

In any event, all of the materials are selected such that they can be sealed together, giving due consideration to the product to be packaged. The lines of seals may extend through the entire side walls, including all plies thereof, to form a secure pouch seal.

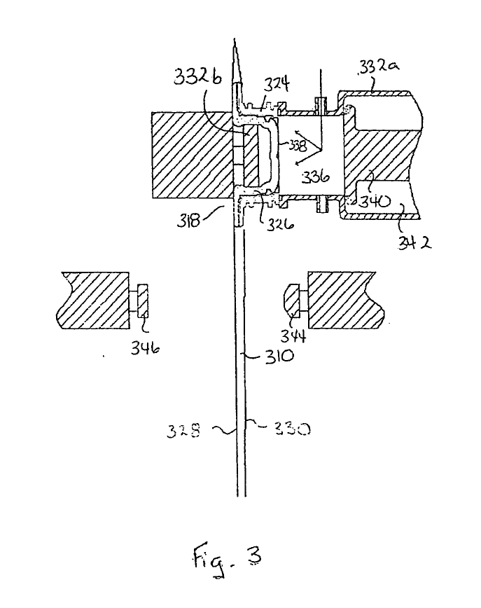

In one embodiment, the bag to which the fitment is attached comprises a pair of multi-ply structured walls with oxygen/moisture barrier layers for enclosing a volume that contains liquid foodstuff. To shape the bag the outer edges of the multiple layers of film are cut and sealed. To engage the fitment 118, 218, a pair of aligned holes (not shown) are cut through the walls of the bag. The body of a spout member (324 in FIGS. 3 to 7) of the fitment 118, 218, with a plug member (326 in FIGS. 3 to 7) located within the passageway of the spout member (324), is then pushed through the hole from the inside of the bag. Methods of pulling and/or pushing the plug member (326) within the spout member (324) are known in the art. For example, U.S. Pat. No. 4,731,978 describes a machine for aseptic filling of containers including a spout and plug member. The outward directed flanges from both the plug member and the spout member remain inside the container. A sealing device then fastens the flanges of the spout member and the plug member with an annular seal independently to the inner surface of each opposing wall inside the container. Sealing the plug member and spout member to the bag walls in an assembled state in the same process ensures the alignment of the sleeve axis for both parts.

Bags of the present invention may suitably be formed by heat-sealing the sides of a sheet of film and heat sealing the fitment. The fitment may further be provided with a snap-fit cap. The fitment or fitment and cap should be designed so as to be hermetic to micro-organisms at production tolerances. Bags of the present invention may suitably be provided for filling as a continuous strip of pre-capped, pre-sterilized bags with perforation between each bag. Where the aseptic package is a bag-in-box application, the strip of bags may be packed into the inner liner in a box. Prior to filling, the interior of the bag may be sterilized, suitably through irradiation, i.e. such as by 3.5 Mrad cobalt gamma irradiation. This may be done by a manufacturer of bag 110, 210 for subsequent shipment to a purchaser for filling.

The bag 110, 210 of the present invention will now be described in use on a filling machine with reference to FIGS. 3, 4, 5, 6 and 7, including a discussion of the filling operation. In FIGS. 3 to 7, the parts are numbered in the three-hundreds, and like parts are shown using the same numbers in the second and third positions. The bag 310 includes the fitment 318 with a spout member 324 and a plug member 326. In this embodiment, the bag 310 is made from a pair of multi-ply structured walls 328, 330 of flexible material.

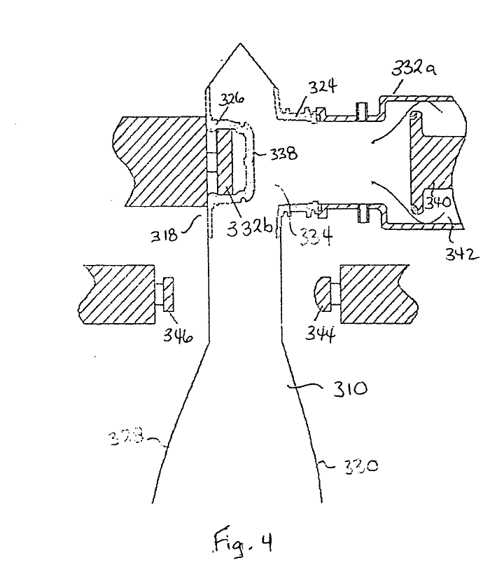

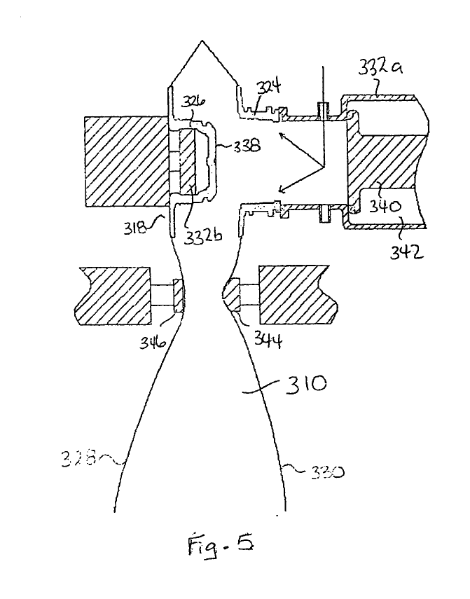

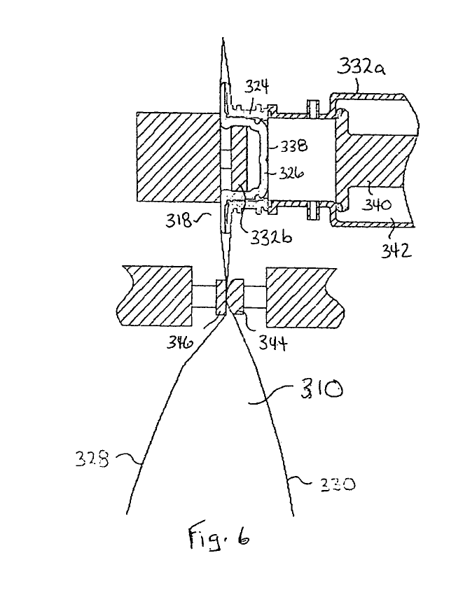

FIGS. 3, 4, 5, 6, and 7 illustrate the filling method using one embodiment of the fitment 318 of the present invention. It will be understood that the filling procedure may be the same for other fitment embodiments. To fill the flexible container 310, the spout member 324 and the plug member 326 are both brought into engagement with the operating equipment 332a and 332b of the filling machine, which holds the spout member 324 tight against the filling opening 334 of the filling machine and moves the plug member 326 to open and close the bag 310. Before the filling process and as shown by the arrows in FIG. 3, high-pressure steam is introduced into chamber 336 formed by the fitment 318 and the filling opening 334. After the steam sterilization of the surface 338 of the leading end of the plug member 326 and of the filling opening 334, the plug member 326 is pulled into the bag 310 and at the same time a filling valve 340 opens as illustrated in FIG. 4. As shown by the arrows in FIG. 4, the product is forced into the bag 310 under the pressure of a supply line 342. When the filling process is finished, the filling valve 340 closes the supply line 342, and the filling paths are cleaned by steam flush as shown in FIG. 5. Thereafter, the plug member 326 is pushed from the inside of the bag 310 into the passageway of the spout member 324 to close the fitment 318 and provide an aseptic seal and a sealing bar 344 and sealing rubber 346 are closed to form a heat seal 323 as shown in FIG. 6. The seal 323 is formed through all the layers of the multilayer bag structure and separates the product from the closed fitment 318.

In an alternative embodiment of the present invention, the bag 310 is also cut away from at least a portion of fitment portion 316 with the fitment 318 during or after the sealing process as shown in FIG. 7. The cut can be achieved either with a knife (not shown) or with the combination of heat and pressure from the sealing bar 344 and sealing rubber 346. The bag 310 (and the aseptic package 312 formed therefrom) may further include a dispensing fitment (not shown).

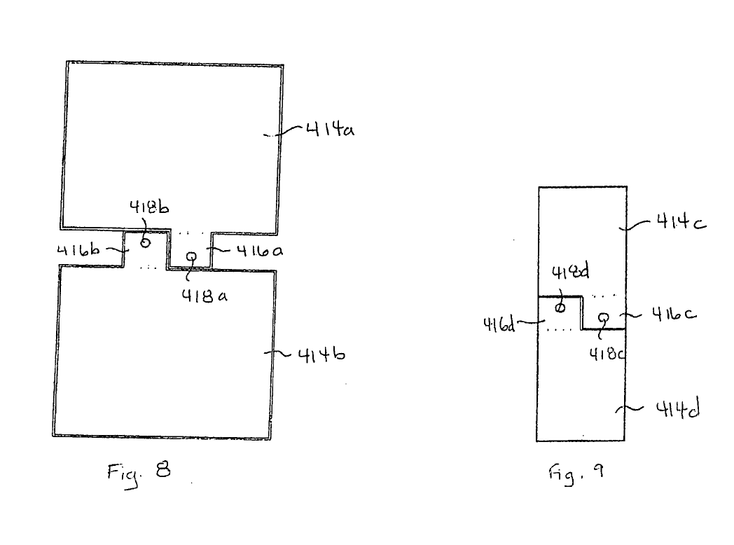

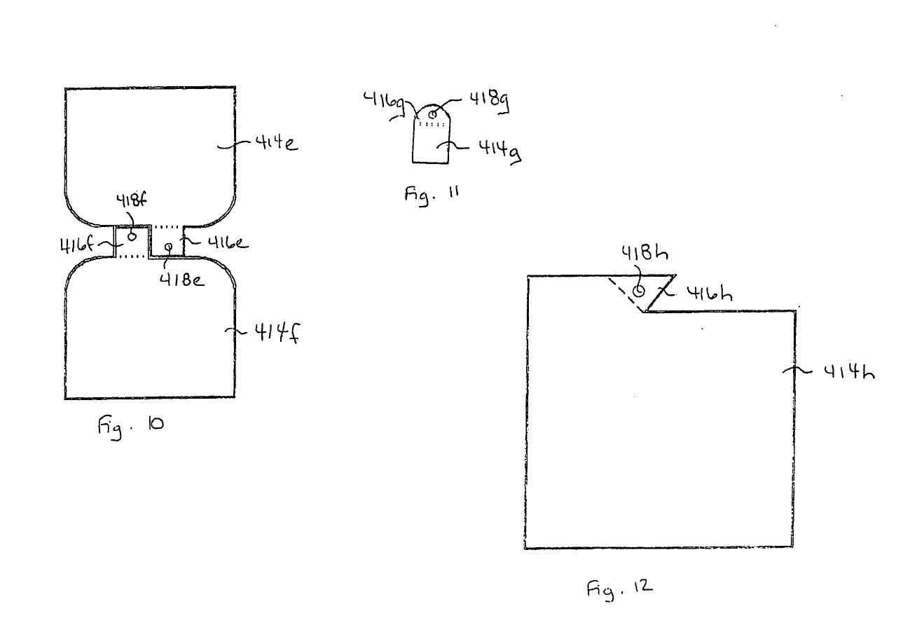

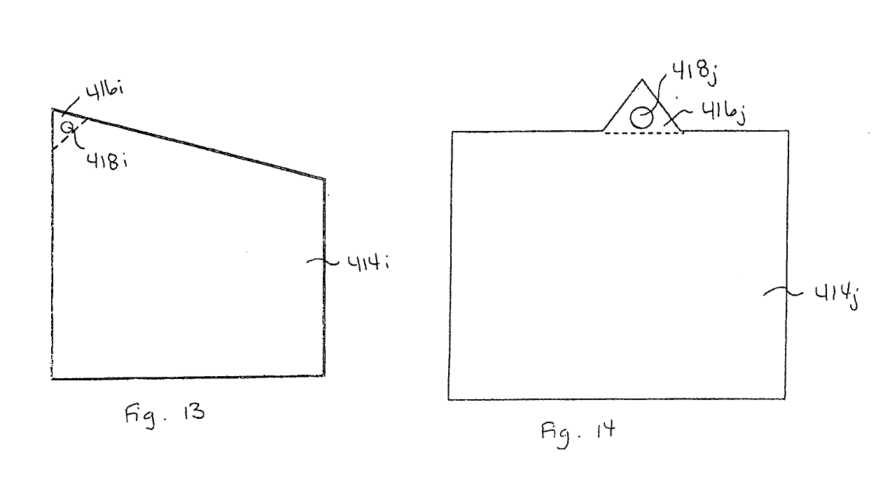

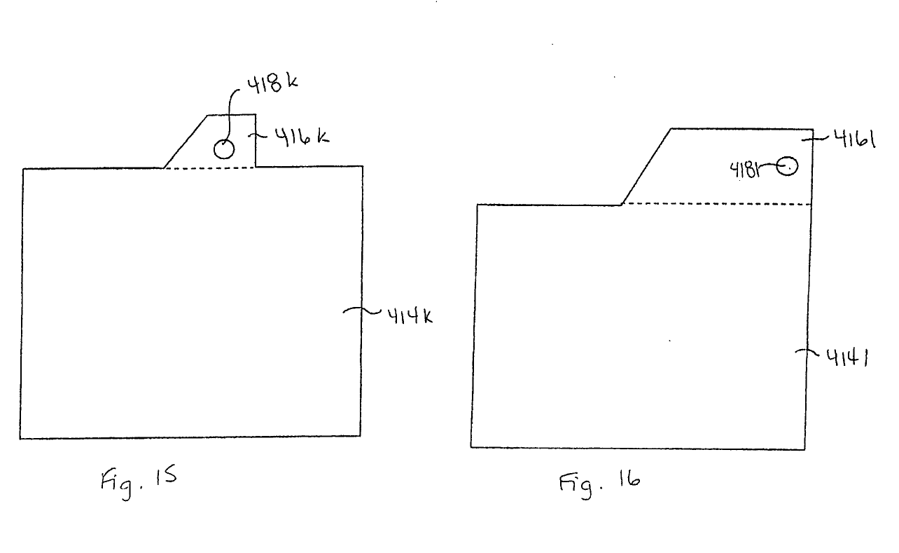

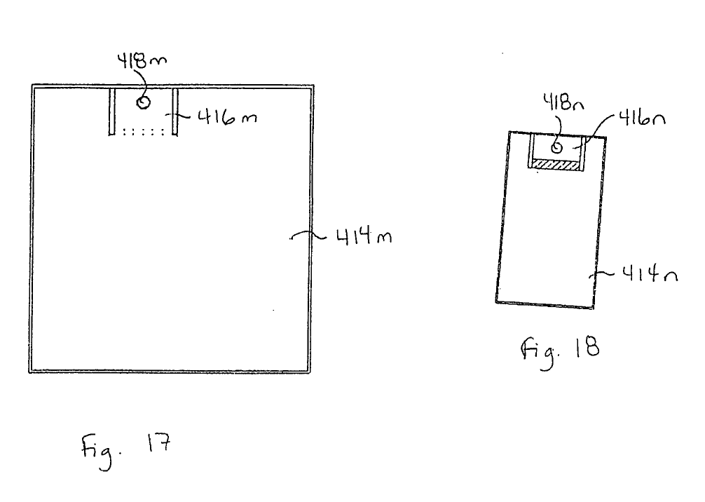

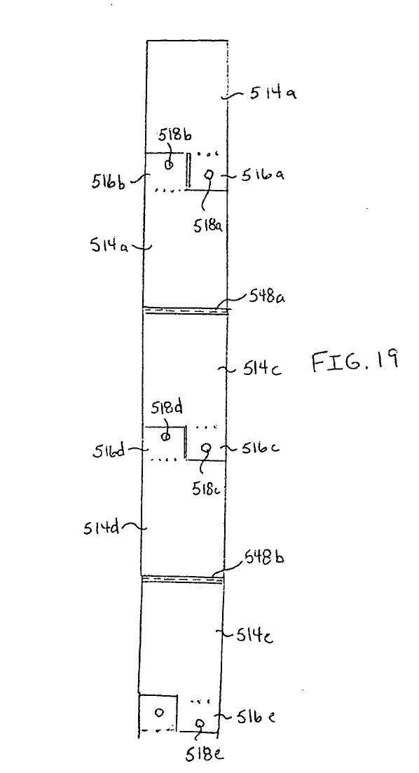

FIGS. 8 through 18 show various shapes suitable for embodiments of the bag of the present invention. In FIGS. 8 through 18, parts are numbered in the four-hundreds, and like parts are shown using the same numbers in the second and third positions. While in FIGS. 8 through 16, the volume of fitment portions 416 is reduced as a result of varying the shape of bag 410 from the generally square or rectangular shape that is typical in the industry, in FIGS. 17 and 18, the reduced volume fitment portion 416 is formed via the formation of internal vertical seals. As will be apparent to a person skilled in the art, this embodiment is particularly suitable for a package of the invention formed by a sealing operation rather than a sealing-and-cutting operation. In this embodiment the reduced volume of the fitment portion is the result of internal barriers. Suitable seal or seal-and-cut lines for forming aseptic sealed product-filled packages of the present invention are shown by single- or double-dotted lines in FIGS. 8 to 17. In the case of FIG. 18, the hatched portion indicates a location suitable for a preseal, which may be subsequently sealed to form a package of the present invention. As will be apparent to a person skilled in the art, different bag designs will be more appropriate for different sizes of bags and for different applications.

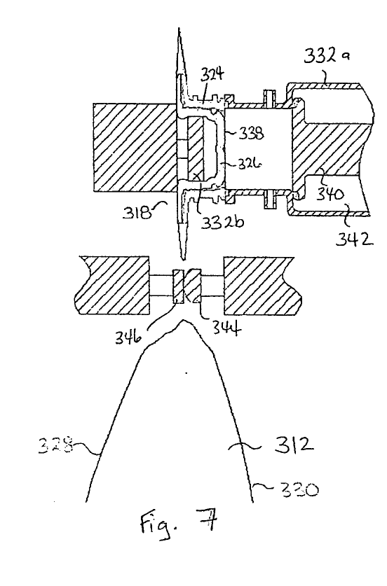

As mentioned above, and as shown in FIG. 19, the present invention includes a continuous strip of pre-capped and pre-sterilized bags with perforation 548a, 548b between each bag. FIG. 19 shows such a strip of the bag design of FIG. 9. In FIG. 19, the parts are numbered in the five-hundreds, and like parts are shown using the same numbers in the second and third positions.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description.

All publications, patents and patent applications referred to herein are incorporated by reference in their entirety to the same extent as if each individual publication, patent or patent application was specifically and individually indicated to be incorporated by reference in its entirety.

What is claimed is:

1. A process for making an aseptic sealed product-filled package, comprising the steps of:
providing a bag having a preformed filling fitment;
filling the bag with product through the filling fitment; and
sealing the bag below the filling fitment.

2. The process of claim 1, further including the step of cutting off at least a portion of the bag above the seal to remove the filling fitment.

3. The process of claim 1, wherein the step of sealing the bag below the fitment is performed by heat sealing.

4. The process of claim 2, wherein the step of cutting off at least a portion of the bag above the seal is performed simultaneously with the step of sealing the bag below the filling fitment.

5. The process of claim 1, further comprising the step of cleaning the fitment.

6. The process of claim 1, wherein the filling fitment is suitable only for filling the bag.

7. The process of claim 1, wherein the step of providing the bag comprises:
providing a first and a second layer of a flexible sealable film material;
cutting and sealing the first and second layers about a common periphery to form a pre-bag having a first wall and a second wall corresponding to the first layer and the second layer;
cutting a first hole through the first wall and a second hole through the second wall, the first and second holes being aligned;
providing a fitment having a spout member and a plug member;
attaching the spout member to the first wall so as to extend out from the first hole;
and attaching the plug member to the second wall so as to extend into the pre-bag through the second hole and so as to be aligned with the spout member.

8. The process of claim 7, wherein the first and second holes are cut near a periphery of the bag.

9. An aseptic sealed product-filled package formed by the process of claim 1.

10. An aseptic sealed product-filled package formed by the process of claim 2.

11. A bag for forming an aseptic product-filled package, comprising:
a pair of corresponding walls of flexible, sealable material, sealed about a common periphery to form an internal volume having a product portion and a fitment portion, the product portion and the fitment portion being fluidly connected;
a filling fitment attached to at least one of the walls near the common periphery;
the package being formable by aseptically sealing at least a part of the fitment portion with the fitment so as to isolate the fitment from the remainder of the bag.

12. The bag of claim 11, wherein the package is formed by the additional step of cutting off at least a part of the bag above the seal including the fitment.

13. The bag of claim 11 wherein the fitment portion has a smaller volume than the product portion.

14. The bag of claim 13 wherein the external dimensions of the bag are sized so that the fitment portion has a smaller volume than the product portion.

15. The bag of claim 13 wherein the fitment portion has a smaller volume than the product portion due to internal barriers in the bag.

16. The bag of claim 11, having a volume of between 55 gallons and 300 gallons.

17. The bag of claim 11, wherein the filling fitment is suitable only for filling the bag.

18. The bag of claim 11, further comprising a dispensing fitment.

19. The bag of claim 15, wherein the internal barriers are formed by heat seals.

20. A strip of bags according to claim 11 connected by perforation.

21. A process for manufacturing a bag for forming an aseptic product-filled package, the process comprising the steps of:
providing a first and a second layer of a flexible sealable film material;
cutting and sealing the first and second layers about a common periphery to form a pre-bag having a first wall and a second wall corresponding to the first layer and the second layer and an internal volume having a product portion and a fitment portion, the product portion and the fitment portion being fluidly connected;
attaching a filling fitment to at least one of the walls near to the common periphery;
wherein the package is formable by aseptically sealing at least a part of the fitment portion with the fitment so as to isolate the fitment from the remainder of the bag.

22. The process according to claim 1, wherein said bag comprises:
(i) a pair of corresponding walls of flexible, sealable material, sealed about a common periphery to form an internal volume having a product portion and a fitment portion, the product portion and the fitment portion being fluidly connected; and
(ii) a filling fitment attached to at least one of the walls near the common periphery;
wherein the package is formable by aseptically sealing at least a part of the fitment portion with the fitment so as to isolate the fitment from the remainder of the bag.
